(19) United States
(12) Patent Application Publication
(10) Pub. No.: US 2016/0211913 A1
(43) Pub. Date: Jul. 21, 2016

(54) SYSTEM AND METHOD OF VISIBLE LIGHT COMMUNICATION BASED ON LED ILLUMINATION

(71) Applicant: Shenzhen Eastfield Lighting Co., Ltd., Shenzhen (CN)

(72) Inventor: Xiaobing Cao, Shenzhen (CN)

(21) Appl. No.: 14/997,931

(22) Filed: Jan. 18, 2016

(30) Foreign Application Priority Data
Jan. 20, 2015 (CN) 201510028334.4

(51) Int. Cl. H04B 10/116; H04B 10/61; H04B 10/50

(52) U.S. Cl. CPC H04B 10/116; H04B 10/502; H04B 10/61

(57) ABSTRACT

A visible light communication system based on LED illumination, comprising: a visible light generating module configured to convert data to be transmitted into a visible light digital signal; a visible light control module configured to set a visible light emitting state of the visible light generating module; a visible light encoding module configured to receive the visible light digital signal, and encode the visible light digital signal; a visible light receiving module configured to communicate with a mobile terminal; and a visible light emitting module configured to transmit the encoded optical signal to the visible light receiving module.

### RELATED APPLICATIONS

This application claims priority under 35 U.S.C. §119 to Chinese Patent Application No. 201510028334.4, filed Jan. 20, 2015. The entire teachings of the above application are incorporated herein by reference.

### FIELD OF THE INVENTION

The present disclosure relates to communication technologies, and more particularly relates to a system and a method of visible light communication based on LED illumination.

### BACKGROUND OF THE INVENTION

Wireless technology has an incontrovertible effect on humans. Nowadays, there are nearly 150,000 people becoming new wireless subscribers every day, and the number of wireless subscribers around the world is now over 200 million. Since the 1970s, humans have started researching wireless networks. Through the 1980s, with a rapid development of Ethernet LAN and a quick popularization of intelligent devices, the rapid increasing of user quantity and user requirements of high rate broadband multimedia communication results in a spectrum resource tension in wireless access networks, coupled with electromagnetic interference and electromagnetic confinement environment or electromagnetic signal sensitivity, most of the wireless networks may generate electromagnetic radiation interference and have relatively low confidentiality.

### SUMMARY OF THE INVENTION

Accordingly, it is necessary to provide a system of visible light communication based on LED illumination with high confidentiality.

A visible tight communication system based on LED illumination, comprising: a visible light generating module configured to convert data to be transmitted into a visible light digital signal; a visible light control module configured to set a visible light emitting state of the visible light generating module; a visible light encoding module configured to receive the visible light digital signal, and encode the visible light digital signal; a visible light receiving module configured to communicate with a mobile terminal; and a visible light emitting module configured to transmit the encoded optical signal to the visible light receiving module.

In addition, a method of visible light communication based on LED illumination is also provided, which includes the following steps: converting data to be transmitted into a visible light digital signal; encoding the visible light digital signal; and transmitting the encoded optical signal to a receiving terminal, wherein the receiving terminal is capable of communicating with a mobile terminal.

In the system and the method of visible light communication based on LED illumination described above, the data to be transmitted is converted into the visible light digital signal by the visible light generating module, and the visible light emitting state of the visible light generating module is set by the visible light control module. The visible light digital signal is encoded by the visible light encoding module, and at last, the encoded optical signal is transmitted by the visible light emitting module and the visible light receiving module. Therefore, the visible light receiving module communicated with the mobile terminal can transmit the data to the mobile terminal. Since the above process is transmitted with visible optical signals, when the confidentiality is required, the leakage of the transmitting data can be prevented by simply shielding the visible light.

### BRIEF DESCRIPTION OF THE DRAWINGS

In order to describe the manner in which the above-recited and other advantages and features are capable of be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a block diagram of a system of visible light communication based on LED illumination in accordance with one embodiment; and

FIG. 2 is a flow chart of a method of visible tight communication based on LED illumination in accordance with the embodiment.

### DETAILED DESCRIPTION OF THE EMBODIMENTS

The details of one or more embodiments of the invention are set forth in the accompanying drawings and the description below. Other features, objects, and advantages of the invention will be apparent from the description and drawings.

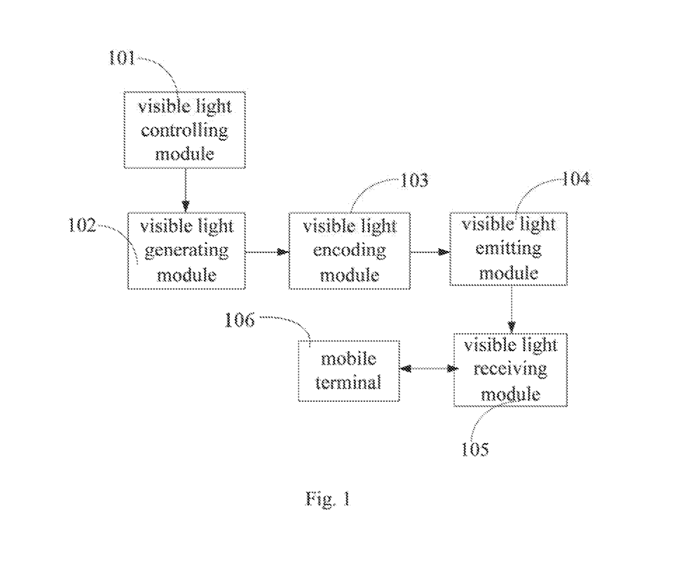

Referring to FIG. 1, an embodiment of a system of visible light communication based on LED illumination includes a visible light control module 101, a visible light generating module 102, a visible light encoding module 103, a visible light emitting module 104, and a visible light receiving module 105.

The visible light control module 101 is configured to set a visible light emitting state of the visible light emitting module 102; the visible light generating module 102 is configured to convert data to be transmitted into a visible light digital signal; the visible light encoding module 103 is configured to receive the visible light digital signal sent by the visible light generating module 102, and encode the visible light digital signal; the visible light emitting module 104 is configured to transmit the encoded optical signal to the visible light receiving module 105; and the visible light receiving module 105 is configured to communicate with a mobile terminal 106.

The visible light generating module 102 includes an LED lamp; emitting states of the LED lamp include an on state and an off state, the on state is corresponding to a high level signal, while the off state is corresponding to a low level signal.

The visible light generating module 102 converts the data to be transmitted into the visible light digital signal by using the high level signals to correspond to the low level signal.

The LED lamp in the on state is capable of emitting optical signal with a transmission rate of 10 to 1.5 Gbit/s.

The LED lamp flashes a million times per second.

The visible light encoding module 103 encodes the data to be transmitted in binary.

The visible light emitting module 104 includes an electro-optical converter, and the electro-optical converter is configured to convert the visible light digital signal into optical signal.

The visible light receiving module 105 includes a light sensor, the light sensor is configured to receive the optical signal outputted by the visible light emitting module 104, and convert the optical signal into a digital signal.

According to all the embodiments described above, a working principle of the system of visible light communication based on LED illumination will be illustrated as follows:

By using the visible light for transmitting data and the optical components such as the LED lamp, on a basis of realizing a tri-networks integration, chips carrying the visible light communication state can be arranged in the circuit of the optical components such as the LED lamp, so as to achieve a new transmission mode of wireless communication with a wireless router, communication base station and GPS functions. In the digital transmission of the illustrated embodiment, the most basic signals are “1” and “0”. The on state of the LED lamp is set to be “1”, while the off state of the LED lamp is set to be “0”, the transmitting of the digital signal can thus be achieved by the state of the LED lamp. Information is transmitted by using the high rate flash that the human eye cannot see emitted by the LED lamp, which flashes a million times per second, therefore, the picked binary signals are rapidly encoded into optical signals and transmitted, and be received by the light sensor. If a chip, including the system of visible light communication based on LED illumination, is implanted into an existed LED lamp (lamps are in every corner), the LED lamp becomes a terminal similar to a Wi-Fi hot spot and is capable of accessing the network at any time. In sufficient conditions, the LED lamp can be wired into a backbone of the network so that all the equipment can be used for wireless communication receiving.

Using the LED lamp light to transmit communication data has a wide bandwidth, a high security and high confidentiality, because it only uses the data after encoding and processing the data, without generating an electromagnetic source that influences people and electrical equipment during the process. The mode of light transmitting information and data of the light of the LED lamp is not required to be licensed by the frequency band, so the access of the high bandwidth and high rate wireless communication can be realized at a low cost. In addition, it also has a very good spatial reuse expanding the coverage of the network in large area, which is a very good complement of radio frequency technology, and is capable of completely meeting the requirements of the next generation of new multimedia communications. For example, by using the LED lamps and other optical components to replace the wireless local area network base station, new infrastructures are no longer needed to be increased; also, it is very safe for no electromagnetic radiation damage on human body to occur. A continuous and high-rate data transmission can be realized in the range of the optical components such as the LED lamp, which has a transmission rate of tens or even hundreds of trillions per second, and a spectrum wider than the radio frequency spectrum. The system of the optical components such as the LED lamp has a very high security, as long as the light is shielded, the information will not leak to outside the light,

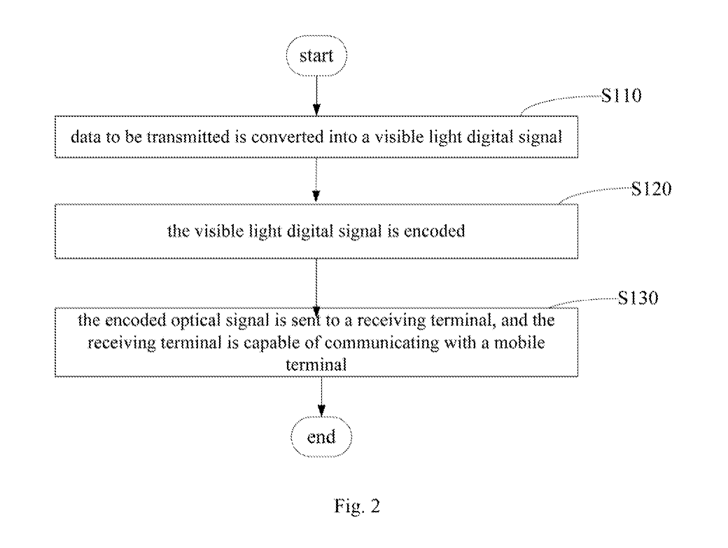

Referring to FIG. 2, FIG. 2 is a flow chart of a method of visible light communication based on LED illumination.

The method of visible light communication based on LED illumination includes the following steps.

In step S110, data to be transmitted is converted into a visible light digital signal.

In step S120, the visible light digital signal is encoded.

In step S130, the encoded optical signal is sent to a receiving terminal, and the receiving terminal is capable of communicating with a mobile terminal 106.

In the visible light digital signal is encoded (step S12), the visible light digital signal is encoded in binary.

In the method and the system of visible light communication based on LED illumination described above, the data to be transmitted is converted into the visible light digital signal by the visible light generating module 102, and the visible light emitting state of the visible light generating module 102 is set by the visible light control module 101. The visible light digital signal is encoded by the visible light encoding module 103, and at last, the encoded optical signal is transmitted by the visible light emitting module 104 and the visible light receiving module 105. Therefore, the visible light receiving module 105 communicated with the mobile terminal 106 is capable of transmitting the data to the mobile terminal 106. Since the above process is transmitted with visible optical signals, when the confidentiality is required, the leakage of the transmitting data can be prevented by simply shielding the visible light.

Although the invention is illustrated and described herein with reference to specific embodiments, the invention is not intended to be limited to the details shown. Rather, various modifications may be made in the details within the scope and range of equivalents of the claims and without departing from the invention.

Although the present disclosure has been described with reference to the embodiments thereof and the best modes for carrying out the present disclosure, it is apparent to those skilled in the art that a variety of modifications and changes may be made without departing from the scope of the present disclosure, which is intended to be defined by the appended claims.

What is claimed is:

1. A visible light communication system based on LED illumination, comprising:
a visible light generating module configured to convert data to be transmitted into a visible light digital signal;
a visible light control module configured to set a visible light emitting state of the visible light generating module;
a visible light encoding module configured to receive the visible light digital signal, and encode the visible light digital signal;
a visible light receiving module configured to communicate with a mobile terminal; and
a visible light emitting module configured to transmit the encoded optical signal to the visible light receiving module.

2. The system of claim 1, wherein the visible light generating module comprises an LED lamp having an on state and an off state, the on state corresponds to a high level signal, while the off state corresponds to a low level signal.

3. The system of claim 2, wherein the visible light generating module is configured to convert the data to be transmitted into the visible light digital signal by using the high level signals to correspond to the low level signal.

4. The system of claim 2, wherein the LED lamp in the on state is capable of emitting optical signal with a transmission rate of 10 to 15 Gbit/s.

5. The system of claim 2, wherein the LED lamp flashes a million times per second.

6. The system of claim 1, wherein the visible light encoding module encodes the data in binary.

7. The system of claim 1, wherein the visible light emitting module comprises an electro-optical converter configured to convert the visible light digital signal into optical signal.

8. The system of claim 7, wherein the visible light receiving module comprises a light sensor configured to receive the optical signal outputted by the visible light emitting module, and convert the optical signal into a digital signal.

9. A method of visible light communication based on LED illumination, comprising the following steps:
converting data to be transmitted into a visible light digital signal;
encoding the visible light digital signal; and
transmitting the encoded optical signal to a receiving terminal, wherein the receiving terminal is capable of communicating with a mobile terminal.

10. The method of claim 9, wherein the encoding the visible light digital signal comprises: encoding the visible light digital signal in binary.
